(19) United States
(12) Patent Application Publication
(10) Pub. No.: US 2013/0325863 A1
(43) Pub. Date: Dec. 5, 2013

(54) Data Clustering for Multi-Layer Social Link Analysis

(71) Applicant: Hongxia Jin, San Jose, CA (US)

(72) Inventor: Hongxia Jin, San Jose, CA (US)

(73) Assignee: International Business Machines Corporation, Armonk, NY (US)

(21) Appl. No.: 13/596,890

(22) Filed: Aug. 28, 2012

Related U.S. Application Data
(63) Continuation of application No. 13/485,062, filed on May 31, 2012.

(51) Int. Cl. G06F 17/30

(52) U.S. Cl. 707/737; 707/E17.046

(57) ABSTRACT

Embodiments of the invention relate to a modeling activity area associated with groups of data items. Tools are provided to profile activity area involvement, both from the data item and from associated participants. The data items are placed into clusters and one or more activity areas are derived from the formed clusters. Each activity area is defined from the perspective of a single user. Participants in an activity area are connected to a user, but not necessarily to each other. The combination of formations of clusters and activity areas provides a multi-facetted organization of connections between data items and associated participants.

### CROSS REFERENCE TO RELATED APPLICATION(S)

This application is a continuation patent application claiming the benefit of the filing date of U.S. patent application Ser. No. 13/485,062 filed on May 31, 2012, and titled “Data Clustering for Multi-Layer Social Link Analysis” now pending, which is hereby incorporated by reference.

### BACKGROUND

This invention relates to clustering of data items. More specifically, the invention relates to discovering activity areas pertaining to the clustered data items and providing a multi-dimensional analysis of the discovered activity areas and associated data items.

With the rapid development of online social network and collaboration systems, social connection among people is on the rise. Either for personal use or business use, social media has become a ubiquitous tool for daily social communication. Social media comes in different formats, and generally consists of documents shared among two or more people. For example, an update may be created by a person and broadcast to friends or followers through a social connection platform.

One task in social network analysis includes identification of an underlying community structure. A community may be in the form of a group of people who are closely linked in a social network, or those who share common interests, but do not necessarily interact directly with each other. Current formations of social linkages among virtual communities are limited. More specifically, such formations are two dimensional and limited to a collapsed evaluation of relationships by calculating an existence or strength between any two entities.

### BRIEF SUMMARY

This invention comprises a method for clustering data and deriving one or more activity areas from the clustered data.

In one aspect, a computer implemented method is provided for implementation of clustering of data and profiling activity area involvement in response to the clustering. Each activity area is a community of interconnected participants. The profiling is based upon a data item and a participant associated with the data item. For example, the participant may be in the form of an author or receiver of the data item. Data items that have been profiled are placed into clusters. Through unified clustering, a best number of resulting clusters is determined. The unified clustering includes partitioning at least two data items into separate clusters through top down clustering, and merging the separate clusters together with hierarchical agglomerative clustering. Following application of the unified clustering, an activity area is derived from the clustered data. Deriving the activity area includes determining a contribution level of each participant involved in each cluster and determining a weight of each topic involved in the cluster. The contribution level of a participant represents strength of the relationship between the participant and a user subject to being profiled for a particular activity area.

In an even further aspect, a computer implemented method is provided for clustering social media data items. Activity area involvement is profiled based upon both the data items and the associated participants. Each activity area is a grouping of interconnected participants. Based upon the profiling, the data items are placed into clusters, including an automatic determination of a number of resulting clusters from the profile activity area involvement. Placement of data items into clusters includes performance of unified clustering for the social media data items. Following placement into clusters, an activity area is derived from the clustered data, including determination of a contribution level of each participant involved in each cluster and a weight of each topic involved in each cluster, with the weight reflecting strength of a relationship between each participant and a user subject to profiling for a particular activity area.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a single facetted view of social connections among users.

FIG. 2 depicts a multi-facetted view of social connections among users.

FIG. 3 depicts a flow chart illustrating an overview of data analysis to derive the activity area(s).

FIG. 4 depicts a flow chart illustrating clustering techniques.

FIG. 5 depicts a flow chart illustrating a process for deriving activity areas.

FIG. 6 depicts a block diagram illustrating tools embedded in a computer system to support a technique employed for clustering data and creating activity areas based on analysis of the clustered data.

FIG. 7 depicts a block diagram showing a system for implementing an embodiment of the present invention.

FIG. 8 depicts a cloud computing node according to an embodiment of the present invention.

FIG. 9 depicts a cloud computing environment according to an embodiment of the present invention.

FIG. 10 depicts abstraction model layers according to an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit(s) described in this specification has been labeled with tools in the form of managers. A manager may be implemented in programmable hardware devices such as field programmable gate arrays, programmable array logic, programmable logic devices, or the like. The managers may also be implemented in software for processing by various types of processors. An identified manager of executable code may, for instance, comprise one or more physical or logical blocks of computer instructions which may, for instance, be organized as an object, procedure, function, or other construct. Nevertheless, the executable of an identified manager need not be physically located together, but may comprise disparate instructions stored in different locations which, when joined logically together, comprise the managers and achieve the stated purpose of the managers.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a profile manager, a cluster manager, a partition manager, a merge manager, an activity manager, an assignment manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

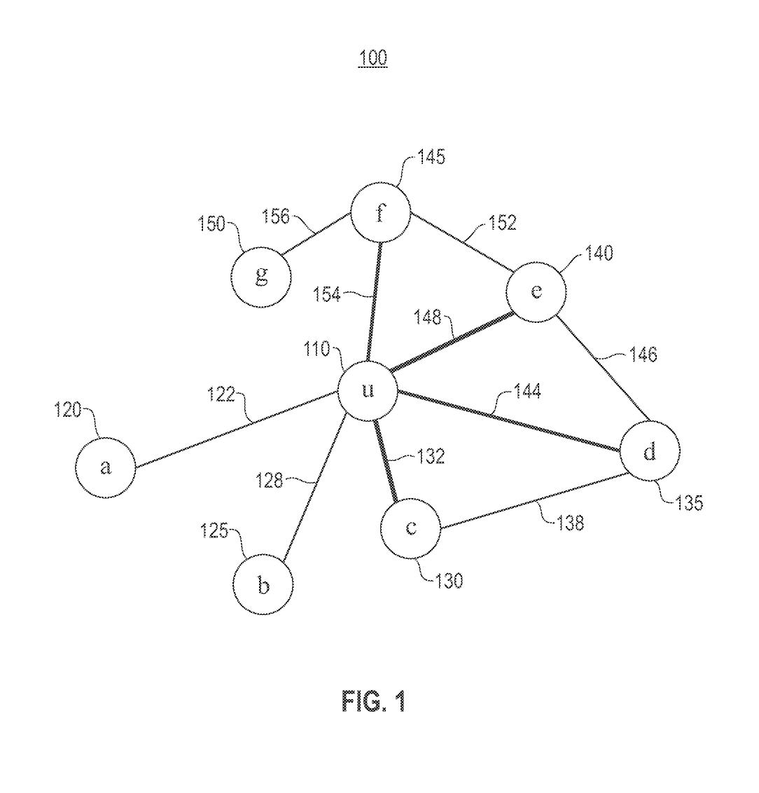

A multi-faceted view of social connections provides multi-dimensional insight into collaboration and allows one to know activities, who else is involved in activities, and levels of activeness within each activity. FIG. 1 is a diagram (100) illustrating a single facetted view of social connections among users, also referred to herein as participants. As shown, the view is centered on user u (110) and the social connections associated with user u (110). Specifically, seven users are shown linked to user u (110), including user a (120), user b (125), user c (130), user d (135), user e (140), user f (145) and user g (150). User a (120) is linked (122) to user u (110), but is not linked to any other users. Similarly, user b (125) is separately linked (128) to user u (110). However, there is no relationship between user a (120) and user b (125). User c (130) is separately linked to user u (110) and user d (135) at (132) and (138), respectively. Similarly, user d (135) is linked to user c (130), user u (110) and user e (140) at (142), (144), and (146), respectively. User e (140) is linked to user d (135), user u (110) and user f (145) at (146), (148), and (152); and user f (145) is linked to user e (140), user u (110) and user g (150) at (152), (154), and (156), respectively. Each of the links shown herein between two users has an associated line weight that reflects the associated relationship. A heavier line weight is reflective of a strong relationship, and a lighter line weight is reflective of a weak relationship. Accordingly, in a single facetted view each user may be linked to one or more users.

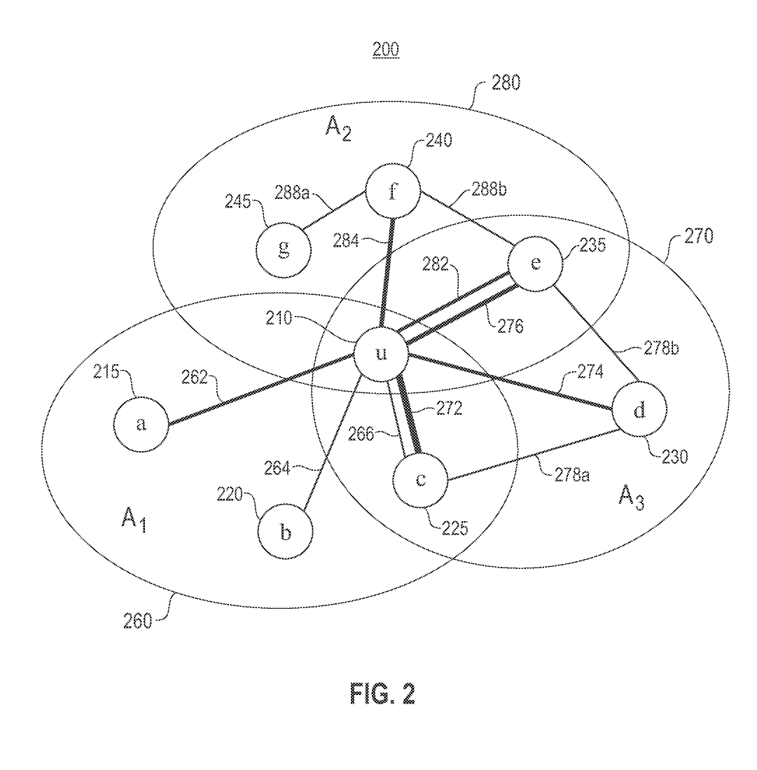

A multi-facetted view of relationships among users provides an understanding of what activities area important to each user, and who is important in each defined activity. More specifically, a multi-facetted view provides a multi-dimensional definition of relationships among users. FIG. 2 is a diagram (200) illustrating a multi-facetted view of social connections among users. As shown, there are eight users illustrated in the example shown herein. In one embodiment, there may be a different quantity of users, and as such, the invention should not be limited to the quantity illustrated. The users include user u (210), user a (215), user b (220), user c (225), user d (230), user e (235), user f (240), and user g (245). User a (215), user b (220), and user c (225) are each separately linked to user u (210) at (262), (264), and (266), respectively. At the same time, user a (215), user b (220), user c (225), and user u (210) are in a first defined activity area (260). User c (225), user d (230), and user e (235) are each separately linked to user u (210) at (272), (274), and (276), respectively. In addition, user c (225) and user d (230) share a link (278a), and user d (230) and user e (235) share a link (278b). At the same time, user c (225), user d (230), user e (235), and user u (210) are in a second defined activity area (270). User e (235), user f (240), and user g (245) are each separately linked to user u (210) at (282), (284), and (286), respectively, and user f (240) has a separate link (288) to user g (245). At the same time, user e (235), user f (240), user g (245), and user u (210) are in a third defined activity area (280). As shown, each activity area is defined from the perspective of a single user. Participants in an activity area are connected to a single user, but not necessarily with each other. Each separate link shown herein has an associated line weight, with the line weight reflecting the strength of a relationship between two users.

From a service provider's perspective, a deeper understanding of a user and associated social relationships enables provision of personalized services. For example, it may enable prioritization of incoming messages or feeds while mitigating information overload. With respect to FIG. 2, if the first activity area (260) and the third activity area (280) are equally important to user u (210) then a communication from user c (210) in the second activity area (270) has greater importance than a communication from user c (210) in the first activity area (260), as reflected by the associated weight of the link (272) as compared to link (266). Accordingly, the multi-facetted organization of users and associated activity areas provides insight into collaboration of different groups of users in different activity areas.

Knowing what activity area a user is involved with over time creates evidence to characterize the user at an abstract level. Working with multiple different groups of people on one topic may provide that the user is a leader or possesses an expertise in a specific area. Comparisons between topics of different activity areas can provide insight on characteristics of a user. Users are grouped into activity areas based upon data items, which may come from the same source or different sources. A data item is represented at a tuple {W,U,T,r}, where W is its textual content, U is the people involved, e.g. the senders and receiver of a message, T is the time-stamp of the item, and r is a binary indicating how the user reacts to the item. In one embodiment, if a user actively involves in a data item, the item's reaction flag is 1, otherwise the reaction flag is 0. For example, if the user composes or replies to a message, the reaction flag is 1. Similarly, if the user ignores the message or does not respond to the message, the reaction flag is 0. Intuitively, items with reaction flag 1 are more likely to be perceived as important by the user than those with reaction flag 0.

An activity area is represented as a tuple {G, f_{w}, fᵤ, tl, sₚ}, where G is a set of data items, f_{w} and fᵤ are functions that return the activeness weights of a given word or contribution level of a given participant in the activity area, respectively, tl is the label, and sₚ is a real-number important score. In one embodiment, sₚ is measured based on the user u's activeness in this activity area. Accordingly, the definition of an activity area provided herein enriches a community discovered by traditional social network analysis with semantic context as well as each participant's contribution level with the user in the community.

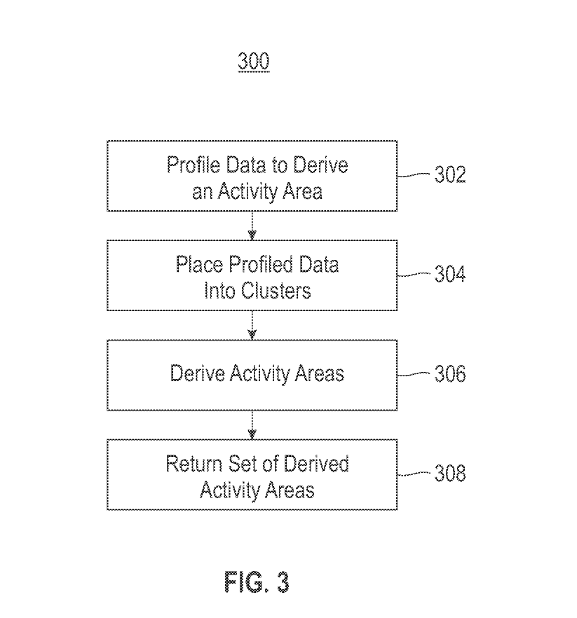

FIG. 3 is a flow chart (300) illustrating an overview of the data analysis to derive the activity area(s). There are three aspects to the overview, including profiling, clustering, and derivation of activity areas. The aspect of profiling activity area involvement is based upon a social media data item and participants associated with the item, including an author or receiver of the data item (302). More specifically, the profiling may include new pieces of social media data items for a user, external knowledge of activity areas for the user, and/or topics and users involved with the topics. The profiled data is placed into clusters (304), and from the clustering of the data one or more activity areas are derived (306). The aspect of clustering the data at step (304) includes both partitioning the data items into separate clusters using a top down clustering technique and merging together the separate clusters using hierarchical agglomerative clustering. Following step (306), a set of activity areas for a user are returned (308).

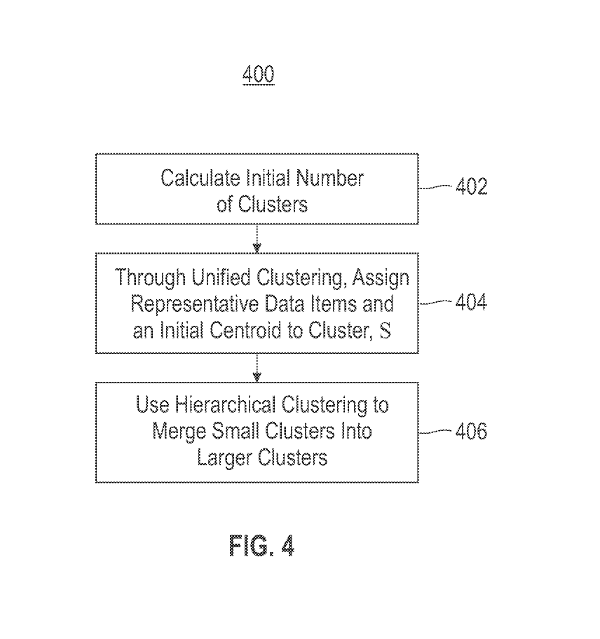

There are two sequential aspects to placing the social media data items into clusters, including a top down clustering technique and a hierarchical agglomerative clustering technique, e.g. bottom up. The hierarchical agglomerative clustering technique determines a best number of resulting clusters. FIG. 4 is a flow chart (400) illustrating the clustering techniques. The first step includes calculating the initial number of clusters (402), e.g. set of data items to be grouped together. In one embodiment, the initial number of clusters is calculated based on the following formula:

S=k*logₙk

where k is an estimate of a quantity of clusters and S is an initial number of small clusters. S provides a probabilistic guarantee that for each of the k potential final clusters, at least one of the initial centroids, i.e. center of a cluster, will lead to one of the final clusters. Clustering of data items is used to derive activity areas.

Following step (402), a unified clustering algorithm is employed to assign representative data items and an initial centroid to the cluster, S (404). In the case that there are already known t clusters, (given from user input seeds or from previous clustering), the unified clustering algorithm only assigns representative items and initial centroid to the (s−t) clusters. T is zero if there does not exist any known clusters. In one embodiment, the unified clustering algorithm is a top down procedure that refines assignment of a data item to a cluster in order to maximize an objective function, such as the summation of the similarities between each data item and the centroid assigned to the cluster. The following is pseudo code demonstrating the top down procedure:
1. S=max (n, k logₙ(k)) {S is the number of centroids}
2. Initialization: assign representative data item and initial centroid to S clusters.
3. Loop
4. For all dᵢ that is not the representative of the current s clusters, refine as follows: do
5. Let Cᵢ be the current centroid of the cluster that document di is currently assigned to,
6. Calculate objective function f=Σ_{j=1,}^{j=n-s+t} sim (dⱼ, Cᵣ) where Cᵣ is the centroid of the cluster that document dⱼ is currently assigned to, and r is in [1,S]
7. For all Cₓ where x!=i do
8. Suppose move dᵢ to Cₓ
9. Re-calculate the supposedly new centroid on the move, and re-calculate the supposedly objective function f′ₓ
10. If exist any f′ₓ<f then Σ
11. Actually move document di to Cx where its resulting F′x is the smallest,
12. Re-calculate the centroids after the move and actually assign the new centroid to the clusters.
13. If there was no actual move of any documents then
14. Return
   As demonstrated, for each data item i, as long as it is not the representative data item to a cluster, the algorithm will test to see if moving to another cluster can improve the objective function and, if so the algorithm will move the data item to the best centroid. Representative data items do not get moved. This guarantees that the representative data items in an existing cluster stay in that cluster. Following the move, the new centroid is computed. The refinement process iterates until no data item needs to move to another centroid, e.g. the objective function can no longer be improved.

When calculating the centroid, the algorithm weighs more on the representative data items, and also offers considerable weight to user input to ensure that clusters are generated around such input. In addition, the algorithm weighs the thread size to ensure that a real cluster is likely to be centered on a large thread.

As explained above, similarity measures are a factor in the top down clustering technique. Given two groups of data items, G₁ and G₂, their aggregated tuples <W₁, U₁, T₁> and <W₂, U₂, T₂> are used to calculate and/or measure the similarity between G₁ and G₂. In one embodiment, G₁ and G₂ may contain a single data item. The similarity measures are along different dimensions, namely textual topic, people, and timeline. In one embodiment, these measures may be combined into an overall similarity. The following is a linear combination for assessing similarity:

sim(Tuple_{G1},Tuple_{G2})=β₁·sim(W₁W₂)+β₂·sim(U₁,U₂)+β₃·sim(T₁,T₂)

where β₁, β₂, β₃ε[0,1] are the combination of weights. In one embodiment, where β₁, β₂, β₃ε[0,1] are textual content, people, and time, respectively. Similarly, in one embodiment, they are equally weighted.

To compute sim (W₁,W₂), stop words and other common words are removed from W₁. Kᵢ is defined as the set of unique words in Wᵢ, and tf(Wⱼ, Wᵢ) is the number of occurrences of the keyword wⱼ in Wᵢ. The similarity measure of sim (W₁,W₂) is calculated as follows:

sim(W₁,W₂)=Π_{wεKi}P(w|W₂)^{tf(w}^{ⱼ}^{,W}^{ᵢ}⁾

where P (w|W₂) is the probability that w is chosen from W₂ when given its occurrences in the textual contents of G₂, . . . Gₙ. More specifically, P (w|W₂) is defined as:

P(w|W₂)=tf(wⱼ,Wᵢ)/Σ^{tf}(w,Wᵢ)

where sigma, Σ, is calculated over i=2 to n. Intuitively, P (w|W₂) is large if a percentage of the occurrences of w among W₂, . . . Wₙ is in W₂. The computation of P (w|W₂) attempts to distinguish W₂ from the textual contents of the other groups based on w, while the exponent tf(w, Wᵢ) in the computation of sim (W₁, W₂) represents how important w is with regard to W₁. In one embodiment, smoothing methods are employed to handle special cases where w does not appear in W₂ and/or where w does not appear in any textual content other than W₁. Similarly, in one embodiment, a logarithm may be applied to avoid arithmetic underflow in the computation of sim (W₁, W₂). The computation of sim (U₁, U₂) is similar to the computation of sim (W₁, W₂). In one embodiment, all the values are normalized between [0, 1].

The method described herein for calculating similarities should not be considered limiting. In one embodiment, alternative methods may be employed for the similarity calculation. For example, TF-IDF weighting may be employed to represent W and U with a vector space model and a classic cosine similarity may be used to measure sim (W₁,W₂) and sim (U₁, U₂).

As briefly described above, time may also be considered in the similarity measure to ensure that two items that have a large time span between them are unlikely to belong to the same topic. It is difficult to estimate the probability that an item occurs at a certain time given the time-stamps of other items in the same group. The following is one formula employed to measure the time distance between G₁ and G₂:

sim(T₁,T₂)=α^{d(tc}^{₁}^{,tc}^{₂}⁾

where tc₁ and tc₂ are the means of the time stamps in T₁ and T₂ respectively, d (tc₁, tc₂) returns the number of days between tc₁ and tc₂, and αε[0,1] is a decay factor. The larger the difference is between tc₁ and tc₂, the smaller sim (Tᵢ, T₂). Different criteria functions may be chosen for different clustering purposes. A sample criteria function may be: sim (W₁,W₂)>T H_{w} and sim (U₁,U₂)>T Hᵤ, and/or sim (Tuple_{G1}, Tuple_{G2})>T H, where T H_{w}, T Hᵤ, and T H are the minimum thresholds for similarities. Tuning β₁, β₂, β₃, T H_{w}, and T Hᵤ enables the similarity algorithm to flexibly favor one factor over another. While these parameters have default values, preferences may be provided to favor one factor over another.

The second part of the clustering algorithm is known as bottom up hierarchical clustering (406). Hierarchical clustering is performed to merge small clusters into larger clusters, with each cluster containing a group of data items. The same similarity measure employed in the top down clustering is used to measure the similarity between any two intermediate smaller clusters and to merge the pair with the largest similarities if it also meets the criteria function. The algorithm stops when no more pairs are found.

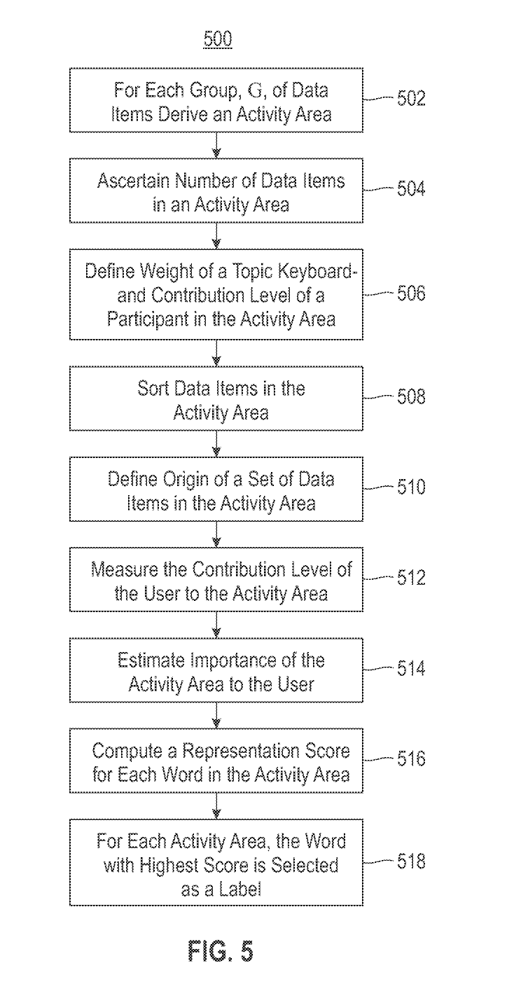

Following the cluster technique(s), one or more activity areas are derived. FIG. 5 is a flow chart (500) illustrating a process for deriving one or more activity areas. For each group G of data items returned by the clustering algorithm, an activity area is derived as {G, f_{w}, fᵤ, tl, sₚ} (502). For a given word wᵢ,f_{w} (wᵢ)=0 if wᵢ is a stop word or a common word; otherwise f_{w} (wᵢ) is the number of data items in G that contain wᵢ in their textual content (504). The weight of a topic keyword and the contribution level of a participant in the activity area are defined (506). In one embodiment, these items are defined as the quotient of the number of items in G that contain the subject keyword and the total number of items in G (506). Next, the contribution level fᵤ(uⱼ) of a participant uⱼ in the activity area based on the content generated for that activity area is measured (506). The list of data items in G sorted by the most recent is defined as L={e₁, . . . , eₘ}, such that eᵢ is more recent that eⱼ when i<j (508). The set of data items that is contributed or generated by a person, p, is defined as Eₚ (510), where rᵢ is 1 if the ith item of L is in Eₚ, and rᵢ is 0 otherwise. The Normalized Discounted Cumulative Gain (NDGC) is employed to measure the contribution level of the user to the activity area derived from G (512). The contribution level of the user is used as the estimate of the importance of the activity area to the user. In one embodiment, the contribution level, sₚ, is estimated as follows:

sₚ=NDCG (L,Ep)=ZₓΣ(2^{ri}−1)/log₂(i+1), for i=1 to x

In one embodiment, Zₓ is selected so that an all-positive list has NDCG value of 1. The contribution level, sₚ, captures the participant's trend of contribution to the activity area and can detect evolving active interest of the participant in different activity areas over time. In one embodiment, the contribution level assessment may be employed to calculate an estimate of the importance of the activity area to the user u over time, sᵤ.

An activity area may labeled, e.g. a label may be applied as a characteristic of the activity area. In one embodiment, a representative keyword is selected to distinguish the activity area. For each defined activity area, a representation score is computed for each word in the activity area (516). For a given word wᵢ, its representation score with regard to an activity area is:

Rs(wᵢ)=f_{w}(wᵢ)log |F|/|Fwᵢ|

where f_{w}(wᵢ) is the weight wᵢ in the activity area, |F| is the total number of user's activity areas, and |Fwᵢ| is the number of the user's activity areas that contain wᵢ as one of their top x keywords. The word with the highest score is selected as a label for the activity area (518).

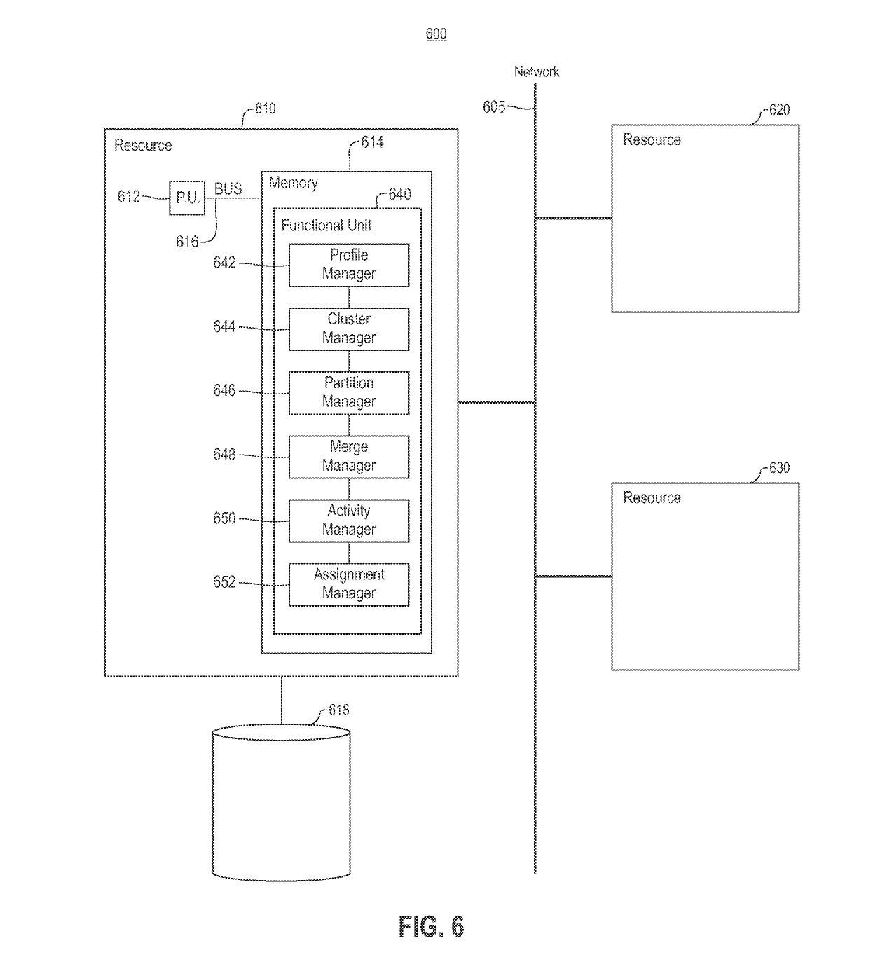

As shown in FIGS. 1-5, a method is provided for a multi-faceted analysis for data clustering. Specifically, content is clustered into groups, and activity areas are derived out of each of the groups. The content may come in different forms, including but not limited to, social media data content. FIG. 6 is a block diagram (600) illustrating tools embedded in a computer system to support a technique employed for clustering data and creating activity areas based on analysis of the clustered data. A computing resource (610) is provided with a processing unit (612), in communication with memory (614) across a bus (616), and in communication with data storage (618). The computing resource (610) is shown in communication with one or more computing resources (620) and (630) across a network (605). As described above, data is gathered and analyzed to form clusters and activity areas. The network (605) is employed as a communication conduit to send and receive data employed in the analysis. Communication among the computing resources is supported across one or more network connections (605).

The computing resource (610) is provided with a functional unit (640) having one or more tools to profile and derive an activity area of data items. The functional unit (640) is shown local to the computing resource (610), and specifically in communication with memory (624). In one embodiment, the functional unit (640) may be local to any of the computing resources (620) and (630). The tools embedded in the functional unit (640) include, but are not limited to, a profile manager (642), a cluster manager (644), a partition manager (646), a merge manager (648), an activity manager (650), and an assignment manager (652).

The profile manager (642) is provided to profile activity area involvement based on data items and participants associated with the data items. The participants include, but are not limited to a sender and a recipient of the data items. The cluster manager (644) is provided in communication with the profile manager (642). The cluster manager (644) functions to place one or more data items into clusters and to automatically determine a best number of resulting clusters. Specifically, the cluster manager (644) performs a unified clustering algorithm for the data items. The unified clustering algorithm employs two tools, a partition manager (646) and a merge manager (648). The partition manager (646) partitions at least two data items into separate clusters using a top down clustering algorithm, and the merge manager (648) merges the separate clusters together with a hierarchical agglomerative clustering algorithm. Following completion of the hierarchical clustering algorithm, the activity manager (650), which is in communication with the cluster manager (644), derives an activity area from the cluster data. Accordingly, the hierarchical clustering algorithm supports formation of one or more activity areas based on the clustering of data.

The activity manager (650) determines a contribution level of each participant involved in each cluster and a weight of each topic involved in the cluster. In one embodiment, the weight is a quotient of a number of items in an activity area that contain a specific value and a total number of items in the activity area. The weight represents the strength of a relationship between participants and the user subject to profiling. Even if the participants are interconnected, the weight is limited to reflecting the relationship with the user subject to profiling. Similarly, the contribution level of a participant is calculated with a normalized discounted cumulative gain score based on all the subject data, and data authored by the participant. The contribution level of a participant represents strength of a relationship between the participant and a user subject to being profiled for a particular activity area. In addition, the activity manager (650) defines a derived activity area to include a calculation of a representative score for each keyword in each activity area. The activity manager (650) selects one or more keywords with a largest representative score as indicia to represent the activity area, e.g. representative indicia. Accordingly, the activity manager (650) functions to define each of the represented activity areas.

In addition to the managers described above, an assignment manager (652) is provided in communication with the activity manager (650). The assignment manager (652) functions to dynamically assign new data to one of the existing activity areas defined by the activity manager (650). Specifically, the assignment manager employs both new data and existing activity areas as input and either assigns the new data to an existing and defined activity area or clusters the new data into a new activity area. Accordingly, the assignment manager (652) addresses the dynamic nature of the activity areas and assignment of new data to an activity area.

As identified above, the cluster manager (644) performs the unified clustering algorithm that incorporates both the top down clustering algorithm and the hierarchical agglomerative clustering algorithm. The partition manager (646) employs the top down clustering algorithm for partitioning data items. More specifically, the top down clustering algorithm initializes the clusters. This includes determination of a centroid of each cluster and assignment of data items to the centroids in an effort to maximize a summation of similarities between each data items and its assigned centroid. The merge manager (648) employs the hierarchical agglomerative clustering algorithm to merge clusters together. More specifically, this algorithm measures similarities between each pair of small clusters and merges pairs of small clusters with a largest similarity measurement. In one embodiment, the unified clustering algorithm includes an initialization and assignment of a selection of centroids based on centers of existing clusters. Accordingly, the cluster manager (644) employs both the partition manager (646) and the merge manager (648) to support a best number of clusters for the data items.

As described above, several managers are provided to support the functionality of profiling data items and derivation of activity areas from the profile data. The managers include a profile manager (642), a cluster manager (644) including a supportive partition manager (646) and merge manager (648), an activity manager (650), and an assignment manager (652). Each of these managers (642)-(652) are shown residing in the functional unit (640) of the server (610). Although in one embodiment, the functional unit (640) and associated managers, respectively, may reside as hardware tools external to the memory (614) of server (610), they may be implemented as a combination of hardware and software, or may reside local to the one or more computing resources (620) and (630) in communication with server (610) across a network (605). Similarly, in one embodiment, the managers may be combined into a single functional item that incorporates the functionality of the separate items. As shown herein, each of the manager(s) are shown local to the server (610). However, in one embodiment they may be collectively or individually distributed across a shared pool of configurable computer resources and function as a unit to profile data and to derive one or more activity areas from the profiled data. Accordingly, the managers may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

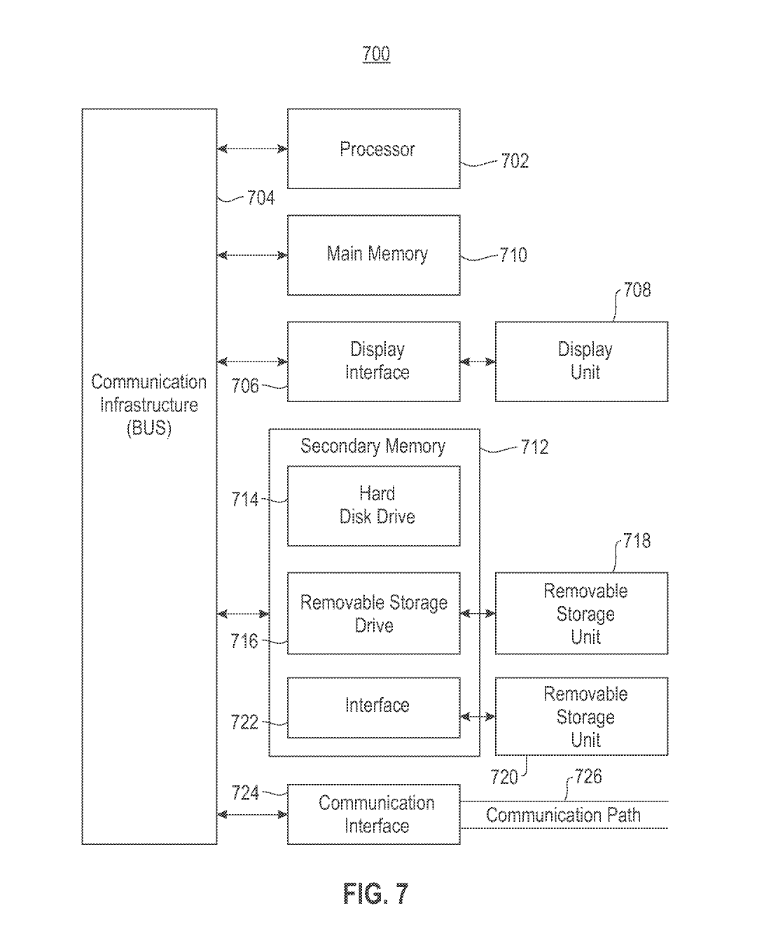

Referring now to FIG. 7 is a block diagram (700) showing a system for implementing an embodiment of the present invention. The computer system includes one or more processors, such as a processor (702). The processor (702) is connected to a communication infrastructure (704) (e.g., a communications bus, cross-over bar, or network). The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712). The secondary memory (712) may include, for example, a hard disk drive (714) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by removable storage drive (716). As will be appreciated, the removable storage unit (718) includes a computer readable medium having stored therein computer software and/or data.

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) are in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the enhanced cloud computing model supports flexibility with respect to clustering of data, including, but not limited to, deriving one or more activity areas for the data and dynamic assignment of new data to an existing activity area or dynamic formation of one or more new activity areas in response to receipt of the new data.

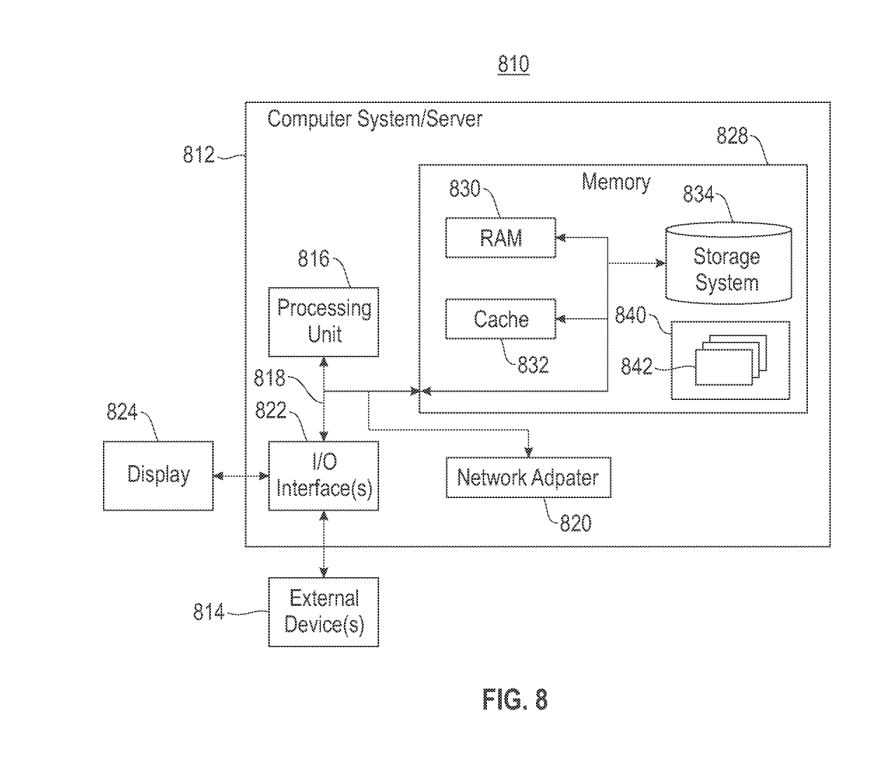

In one embodiment, the clustering of data and derivation of activity areas may take placed in a pool of shared resources, e.g. cloud computing environment. The cloud computing environment is service oriented with a focus on statelessness, low coupling, modularity, and semantic interoperability. At the heart of cloud computing is an infrastructure comprising a network of interconnected nodes. Referring now to FIG. 8, a schematic of an example of a cloud computing node is shown. Cloud computing node (810) is only one example of a suitable cloud computing node and is not intended to suggest any limitation as to the scope of use or functionality of embodiments of the invention described herein. Regardless, cloud computing node (810) is capable of being implemented and/or performing any of the functionality set forth hereinabove. In cloud computing node (810) there is a computer system/server (812), which is operational with numerous other general purpose or special purpose computing system environments or configurations. Examples of well-known computing systems, environments, and/or configurations that may be suitable for use with computer system/server (812) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (812) may be described in the general context of computer system-executable instructions, such as program modules, being executed by a computer system. Generally, program modules may include routines, programs, objects, components, logic, data structures, and so on that perform particular jobs or implement particular abstract data types. Computer system/server (812) may be practiced in distributed cloud computing environments where jobs are performed by remote processing devices that are linked through a communications network. In a distributed cloud computing environment, program modules may be located in both local and remote computer system storage media including memory storage devices.

As shown in FIG. 8, computer system/server (812) in cloud computing node (810) is shown in the form of a general-purpose computing device. The components of computer system/server (812) may include, but are not limited to, one or more processors or processing units (816), a system memory (828), and a bus (818) that couples various system components including system memory (828) to processor (816). Bus (818) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server (12) typically includes a variety of computer system readable media. Such media may be any available media that is accessible by computer system/server (812), and it includes both volatile and non-volatile media, removable and non-removable media.

System memory (828) can include computer system readable media in the form of volatile memory, such as random access memory (RAM) (830) and/or cache memory (832). Computer system/server (812) may further include other removable/non-removable, volatile/non-volatile computer system storage media. By way of example only, storage system (834) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (818) by one or more data media interfaces. As will be further depicted and described below, memory (828) may include at least one program product having a set (e.g., at least one) of program modules that are configured to carry out the functions of embodiments of the invention.

Program/utility (840), having a set (at least one) of program modules (842), may be stored in memory (828) by way of example, and not limitation, as well as an operating system, one or more application programs, other program modules, and program data. Each of the operating systems, one or more application programs, other program modules, and program data or some combination thereof, may include an implementation of a networking environment. Program modules (842) generally carry out the functions and/or methodologies of embodiments of the invention as described herein.

Computer system/server (812) may also communicate with one or more external devices (814), such as a keyboard, a pointing device, a display (824), etc.; one or more devices that enable a user to interact with computer system/server (812); and/or any devices (e.g., network card, modem, etc.) that enable computer system/server (812) to communicate with one or more other computing devices. Such communication can occur via Input/Output (I/O) interfaces (822). Still yet, computer system/server (812) can communicate with one or more networks such as a local area network (LAN), a general wide area network (WAN), and/or a public network (e.g., the Internet) via network adapter (820). As depicted, network adapter (820) communicates with the other components of computer system/server (812) via bus (818). It should be understood that although not shown, other hardware and/or software components could be used in conjunction with computer system/server (812). Examples, include, but are not limited to: microcode, device drivers, redundant processing units, external disk drive arrays, RAID systems, tape drives, and data archival storage systems, etc.

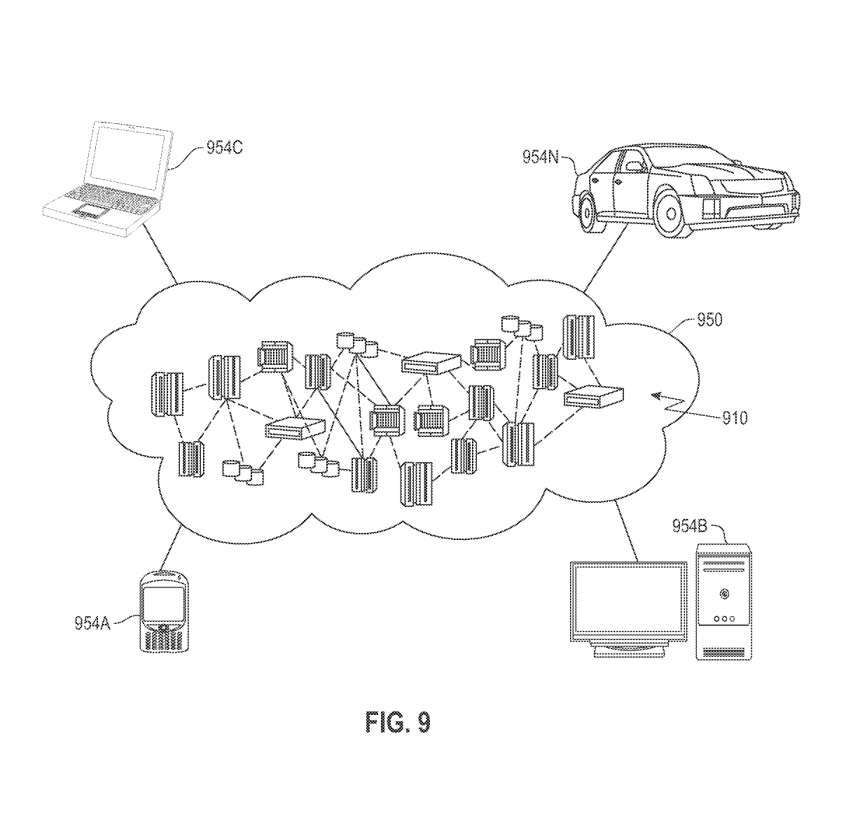

Referring now to FIG. 9, illustrative cloud computing environment (950) is depicted. As shown, cloud computing environment (950) comprises one or more cloud computing nodes (910) with which local computing devices used by cloud consumers, such as, for example, personal digital assistant (PDA) or cellular telephone (954A), desktop computer (954B), laptop computer (954C), and/or automobile computer system (954N) may communicate. Nodes (910) may communicate with one another. They may be grouped (not shown) physically or virtually, in one or more networks, such as Private, Community, Public, or Hybrid clouds as described hereinabove, or a combination thereof. This allows cloud computing environment (950) to offer infrastructure, platforms and/or software as services for which a cloud consumer does not need to maintain resources on a local computing device. It is understood that the types of computing devices (954A)-(954N) shown in FIG. 9 are intended to be illustrative only and that computing nodes (910) and cloud computing environment (950) can communicate with any type of computerized device over any type of network and/or network addressable connection (e.g., using a web browser).

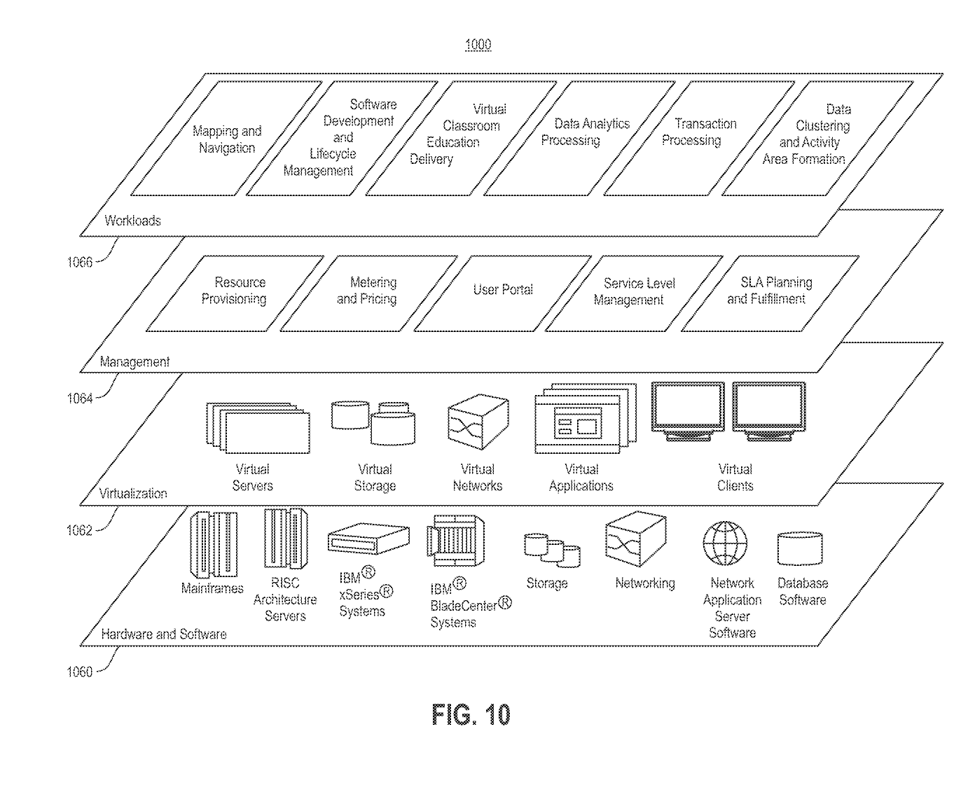

Referring now to FIG. 10, a set of functional abstraction layers provided by cloud computing environment (1050) is shown. It should be understood in advance that the components, layers, and functions shown in FIG. 10 are intended to be illustrative only and embodiments of the invention are not limited thereto. As depicted, the following layers and corresponding functions are provided: hardware and software layer (1060), virtualization layer (1062), management layer (1064), and workload layer (1066). The hardware and software layer (1060) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (1062) provides an abstraction layer from which the following examples of virtual entities may be provided: virtual servers; virtual storage; virtual networks, including virtual private networks; virtual applications and operating systems; and virtual clients.

In one example, management layer (1064) may provide the following functions: resource provisioning, metering and pricing, and user portal. The functions are described below. Resource provisioning provides dynamic procurement of computing resources and other resources that are utilized to perform jobs within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and jobs, as well as protection for data and other resources. User portal provides access to the cloud computing environment for consumers and system administrators.

Workloads layer (1066) provides examples of functionality for which the cloud computing environment may be utilized. Examples of workloads and functions which may be provided from this layer include, but is not limited to: mapping and navigation, software development and lifecycle management, virtual classroom education delivery, data analytics processing, job processing, and data clustering and activity area formation within the cloud computing environment. Data clustering provides cloud computing resource allocation and management such that data items are clustered and activity areas from the clustered data items are formed.

The data clustering and associated formation of activity areas may be extrapolated to function in a cloud computing environment. With respect to FIG. 6, each of the computing resources (610), (620), and (630) may represent a data center with one or more embedded computing resources. Data may be gathered across the shared resources of the computing environment and employed in the clustering algorithm to derive activity areas.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method comprising:
profiling activity area involvement, each activity area being a defined community of interconnected participants, the profiling based upon a data item and participants associated with the data item;
placing the data items into clusters from the profile activity area involvement and automatically determining a number of resulting clusters, including performing unified clustering comprising:
partitioning two or more data items into separate clusters using top down clustering; and
merging the separate clusters together with hierarchical agglomerative clustering; and
deriving an activity area from the clustered data, including determining a contribution level of each participant involved in each cluster, and determining a weight of each topic involved in the cluster, wherein the contribution level of a participant represents a strength of a relationship between the participant and a user under profiling for a particular activity area.

2. The method of claim 1, wherein top down clustering includes initializing the clusters, including determining a centroid for each cluster, the centroid representing a center of the data items in the cluster and assigning other data items to the centroids to maximize a summation of the similarities between each data item and its assigned centroid.

3. The method of claim 1, wherein hierarchical agglomerative clustering includes measuring similarities between each pair of small clusters, and merging pairs of small clusters with a largest similarity measurement.

4. The method of claim 2, wherein the unified clustering further includes initializing and assigning a selection of centroids based on centers of existing clusters.

5. The method of claim 1, wherein the weight is a quotient of a number of items in an activity area that contain a specific value and a total number of items in the activity area.

6. The method of claim 1, wherein the contribution level of a participant is calculated with a normalized discounted cumulative gain score based on all the data items and the data items authored by the participant.

7. The method of claim 1, further comprising defining a derived activity area including calculating a representative score for each keyword in each activity area and selecting at least one keyword with a largest representative score as representative indicia of the activity area.

8. The method of claim 1, further comprising dynamically assigning new data to one of the existing activity areas, including employing the new data and the existing activity areas as input and assigning the new data to an activity area selected from the group consisting of: a close existing area and a new activity area formed from clustering some of the new data.

9. A computer implemented method comprising:
profiling activity area involvement, based upon a data item and participants associated with the data item, each activity area to define a grouping of interconnected participants;
placing the data items into clusters and automatically determining a number of resulting clusters from the profiled activity area involvement, including performing unified clustering for the data items; and
deriving an activity area from clustered data, including determining a contribution level of each participant involved in each cluster, and determining a weight of each topic involved in the cluster, wherein the contribution level of a participant represents a strength of a relationship between the participant and a user under profiling for a particular activity area.

10. The computer implemented method of claim 9, wherein the unified clustering includes: partitioning two or more data items into separate clusters using top down clustering, and merging the separate clusters together with hierarchical agglomerative clustering.
